(19) United States
(12) Patent Application Publication
(10) Pub. No.: US 2010/0311577 A1
(43) Pub. Date: Dec. 9, 2010

(54) CaO Based Carbon Dioxide Absorbent and Method of Making

(75) Inventors: Liyu Li, Richland, WA (US); David L. King, Richland, WA (US); Jun Liu, Richland, WA (US); Kake Zhu, Prosser, WA (US); Zimin Nie, Richland, WA (US); Christopher J. Howard, Richland, WA (US)

Correspondence Address: BATTELLE MEMORIAL INSTITUTE;ATTN: IP SERVICES, K1-53, P. O. BOX 999, RICHLAND, WA, 99352, US

(73) Assignee: BATTELLE MEMORIAL INSTITUTE, Richland, WA (US)

(21) Appl. No.: 12/479,320

(22) Filed: Jun. 5, 2009

(51) Int. Cl. B01J 20/04; B01J 20/30

(52) U.S. Cl. 502/400

(57) ABSTRACT

A method for making a class of relatively stable porous carbon dioxide absorbents by mixing inert nanoparticles with a CaO precursor followed by high temperature calcination. In the preferred embodiments of this invention this process takes place in the essential absence of nitrates. In some embodiments of the invention the method further includes forming the inert nanoparticles-doped porous CaO material by decomposing a mixture of inert particles and CaO precursor material.

### BACKGROUND OF THE INVENTION

1. Field of the Invention

The invention generally relates to absorbents for carbon dioxide capture and particularly to carbon dioxide absorbents containing calcium oxide.

2. Background Information

Increasing concentrations of CO₂ in the atmosphere have been identified as a major contributor to global warming. Much of the increase is due to the consumption of fossil fuels which is expected to continue into the foreseeable future. To mitigate these effects, large scale CO₂ capture and sequestration (CCS) technologies and strategies have been proposed and are currently being widely studied.

The carbonation of calcium oxide materials has been identified as an effective method for removing carbon dioxide from streams of hot gasses. CaO-containing materials provide a variety of advantages due to their high reactivity for CO₂ absorption, high CO₂ capacity, low material cost, and their high carbonation temperature (600-700° C.) which makes it possible to efficiently recover the large amount of energy released during CO₂ capture (178 kJ/mol CO₂).

With proper energy recovery, CaO-based absorbents show great advantage over other absorbents. However, the carbonation and decarbonation reactions of CaO and CaCO₃ are far from complete or reversible. Rapid loss of CO₂ capacity over many carbonation/decarbonation cycles is almost always observed due to absorbent sintering. Absorbent sintering is significantly influenced by several factors including the following: 1) the carbonation process is highly exothermic (CaO+CO₂=CaCO₃ ΔH° =−178 kJ/mol); 2) there is a large volume increase from CaO to CaCO₃ (16.9 cm³/mol to 34.1 cm³/mol), which greatly decreases the distance between absorbent particles in the carbonated state; and 3) CaCO₃ has a Tammann temperature (i.e. the highest treatment temperature before the sintering of a material becomes significant) of 533° C., lower than normal carbonation temperatures.

Various methods have been suggested and researched to attempt to find ways to enhance the durability of CaO-based CO₂ absorbents. So far, three major approaches have been used: 1) incorporation of inert materials, such as MgO, Al₂O₃, ZrO₂, TiO₂, SiO₂, La₂O₃ that physically hinder CaCO₃—CaCO₃ particle sintering; 2) modification of the pore structure of CaO particles; 3) use stable CaO nanoparticles. However, no materials have been indentified yet which can survive thousands of carbonation-decarbonation cycles required by practical applications with acceptable capacities. The present invention is a significant step toward providing such a material.

Additional advantages and novel features of the present invention will be set forth as follows and will be readily apparent from the descriptions and demonstrations set forth herein. Accordingly, the following descriptions of the present invention should be seen as illustrative of the invention and not as limiting in any way.

### SUMMARY

The present invention is a method for making a class of relatively stable porous carbon dioxide absorbents by mixing inert nanoparticles with a CaO precursor followed by high temperature calcination. In the preferred embodiments of this invention this process takes place in the essential absence of nitrates. In some embodiments, the nanoparticles have a mean particle size less than 20 nanometers. In other embodiments, the inert nanoparticles include MgO. In other embodiments of the invention the method further includes forming the inert nanoparticles-doped porous CaO material by decomposing a mixture of inert particles and CaO precursor material. In some embodiments, this decomposition method is performed thermally. The precursor material in one embodiment is Ca(CH₃COO)₂. The step of mixing may be performed by dry mechanical mixing or by other means as deemed necessary and appropriate. The resulting material provides a significant advantage over other materials and methods taught and described in the prior art.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions I have shown and described only the preferred embodiment of the invention, by way of illustration of the best mode contemplated for carrying out the invention. As will be realized, the invention is capable of modification in various respects without departing from the invention. Accordingly, the drawings and description of the preferred embodiment set forth hereafter are to be regarded as illustrative in nature, and not as restrictive.

### BRIEF DESCRIPTION OF THE DRAWINGS

FIG. 1 shows the performances, Performances of CaO absorbents obtained from different sources. Carbonation at 758° C. in 100% CO₂ for 30 min, decarbonation at 758° C. in 100% He for 30 min.

FIG. 2 shows SEM images of fresh and used pure CaO absorbents. FIG. 2a shows fresh CaO from Ca(NO₃)₂; FIG. 2b shows fresh CaO from CaC₂O₄; FIGS. 2c and 2d fresh CaO from Ca(CH₃COO)₂; 2e and 2f. CaO from Ca(CF₃COO)₂ after 53 cycles of carbonation and decarbonation at 758° C.

FIG. 3 shows the effect effect of MgO-doping method on the CO₂ capture performances of 42 wt % MgO-58 wt % CaO absorbents. [[Top]] FIG. 3a shows: CO₂ capacity vs. cyde number; FIG. 3b Bottom: CaO utilization vs. cycle number. Carbonation at 758° C. in 100% CO₂ for 30 min, decarbonation at 758° C. in 100% He for 30 min.

FIG. 4 Carbonation and decarbonation reactions of 42 wt % MgO doped CaO absorbent prepared by physical mixing of Ca(CH₃COO)₂ and MgO. FIG. 4a [[Top]]: 2^{nd} cycle; FIG. 4b Bottom: 50^{th} cycle. Carbonation at 758° C. in 100% CO₂ for 30 min, decarbonation at 758° C. in 100% He for 30 min.

FIGS. 5a-5j show. Cross-section SEM analysis of fresh and used 26 wt % MgO-doped CaO absorbents prepared by physical mixing of Ca(CH₃COO)₂ with MgO FIGS. 5a-e show: fresh samples; FIGS. 5h-j: show the samples after 100 cycles test. FIGS. 5d and 5e show: EDS analysis of selected area in image FIG. 5c. FIGS. 5i and 5j show: Mg and Ca elemental mapping of image h.

FIG. 6 shows the effect Effect of calcination temperature of MgC₂O₄ on the crystallite size of produced MgO particles. Crystal size was estimated from XRD pattern using Scherrer's equation. Duration of calcination at each temperature: 2 hr.

FIGS. 7a and 7b show the effect Effect of MgO doping level on the CO₂ capture performance of three CaO-based absorbents. [[Top]] FIG. 7a shows: CO₂ capacity vs. cycle number; Bottom FIG. 7b: CaO utilization vs. cycle number. Carbonation at 758° C. in 100% CO₂ for 30 min, decarbonation at 758° C. in 100% He for 30 min.

### DETAILED DESCRIPTION OF THE INVENTION

The following description includes one embodiment of the present invention. It will be dear from this description of the invention that the invention is not limited to these illustrated embodiments but that the invention also includes a variety of modifications and embodiments thereto. Therefore the present description should be seen as illustrative and not limiting. While the invention is susceptible of various modifications and alternative constructions, It should be understood, that there is no intention to limit the invention to the specific form disclosed, but, on the contrary, the invention is to cover all modifications, alternative constructions, and equivalents falling within the spirit and scope of the invention as defined in the claims.

The method of the present invention provides a solution to the well-established sintering effect that takes place with CaO-based materials. A class of CaO-based absorbents with improved durability and CO₂ reactivity were prepared by physical mixing of Ca(CH₃COO)₂ with small MgO particles followed by high temperature calcination. With 26 wt % MgO doping a CaO—MgO mixture prepared by this method gives as high as 53 wt % CO₂ capacity after 50 carbonation-decarbonation cycles at 758° C. Without MgO doping, the CO₂ capacity of pure CaO obtained from same source decreases from 66 wt % for the 1^{st} cycle to 26 wt % for the 50^{th} cycle under the same test conditions.

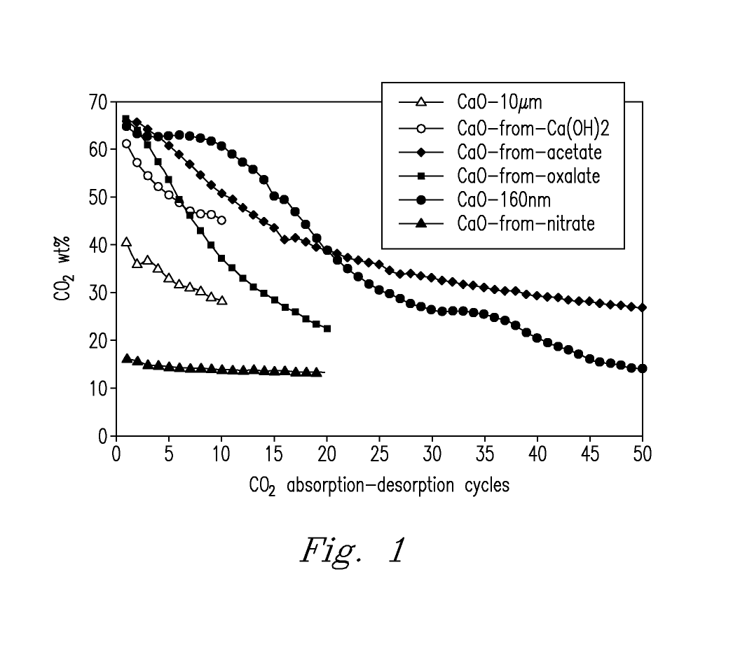

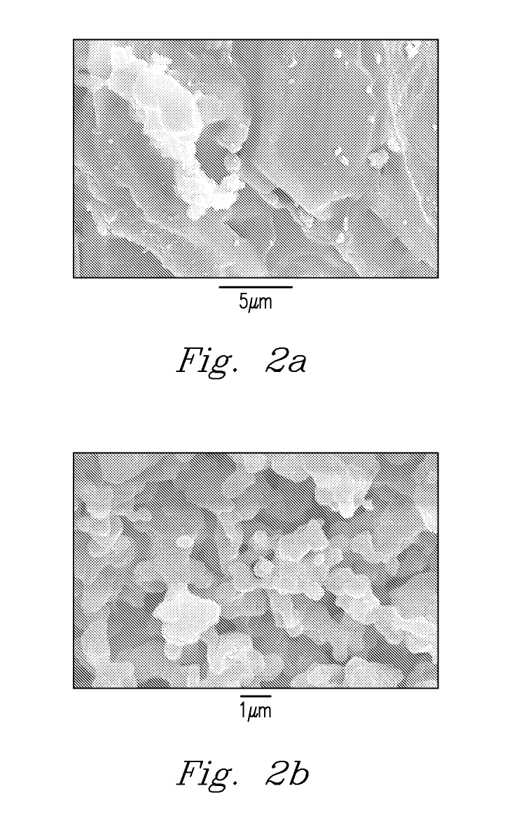

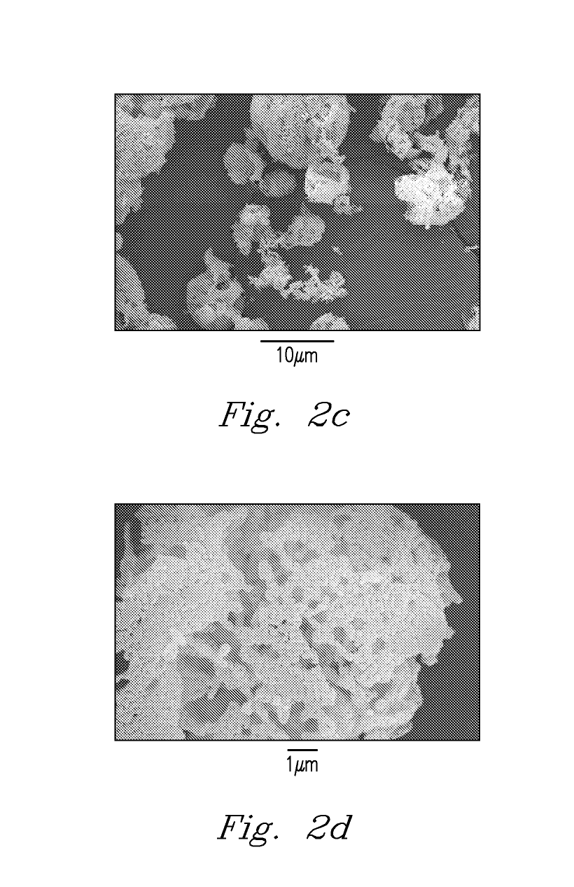

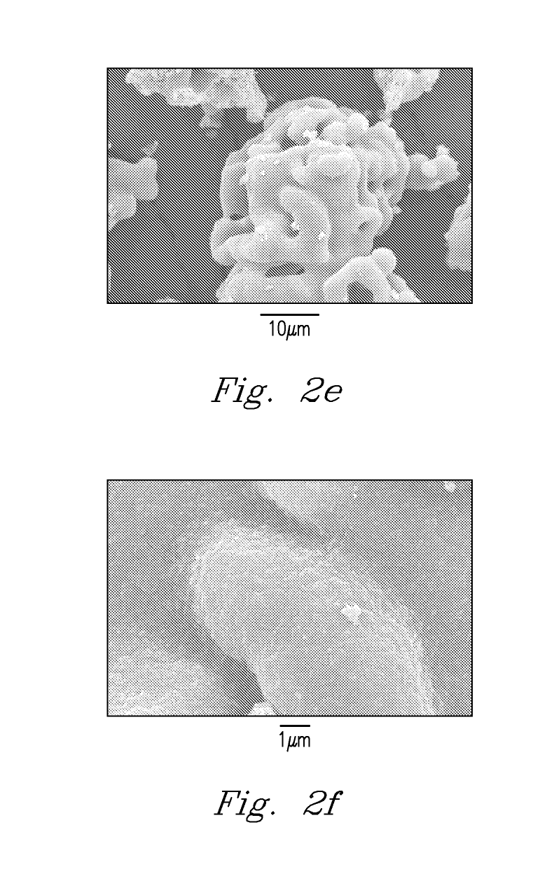

Four pure CaO absorbents were prepared by thermal decomposition of Ca(OH)₂, Ca(CH₃COO)₂, Ca(NO₃)₂, and CaC₂O₄. Their CO₂ capture performances, along with those of two commercial CaO samples (10 μm particles, and 160 nm particles), were evaluated in a TGA unit at 758° C. The results of this testing is shown in FIG. 1. As this figure shows, CaO absorbents obtained from different sources exhibit quite different CO₂ capture performances. Among all the samples tested, CaO prepared by direct decomposition of Ca(CH₃COO)₂ gives the best performance, even better than the commercial 160 nm CaO. FIG. 2 gives SEM images of three fresh CaO samples (decomposition of nitrate, oxalate, and acetate) and one used sample (CaO from acetate, after 52 cycles of carbonation-decarbonation at 758° C.). Decomposition of Ca(NO₃)₂ gives very dense CaO sample. As a result, very poor CO₂ capture performance was observed. Decomposition of Ca(CH₃COO)₂ produces small CaO crystals with unique porous structure. This special structure contributes to its good long-term CO₂ capture performance. Based on this observation, Ca(CH₃COO)₂ was used as major CaO source throughout the rest of this study.

To improve the long-term performance of these CaO-based absorbent, MgO-doping effect was extensively studied. While MgO was used in these examples, it is fully anticipated that a variety of other materials might be alternatively embodied and used in these situations. These include but are not limited to: Al₂O₃, SiO₂, TiO₂, ZrO₂, and lanthanide oxides. The results of the present invention show that best performance was obtained with materials, precursors, substrates that are essentially free of nitrates.

In one set of experiments, three samples with 42 wt % MgO and 58 wt % CaO were prepared using three different methods: co-precipitation, solution mixing, and dry physical mixing of Ca(CH₃COO)₂ with MgO (from decomposition of MgC₂O₄ at 600° C.). The following outlines the materials, methods and testing involved.

Materials and Preparation Methods. Reagent-grade chemicals CaO (160 nm powder), Ca(OH)₂, Ca(NO₃)₂-4H₂O, MgO (325 μm), Mg(OH)₂, Mg(CH₃COO)₂-4H₂O and Na₂CO₃ were purchased from Sigma-Aldrich Co. Reagent-grade chemicals CaO (10 μm), Ca(CH₃COO)₂-0.4H₂O, calcium oxalate CaC₂O₄, dolimite natural mineral CaMg(CO₃)₂, magnesium oxalate MgCO₄-2H₂O and Mg(CH₃COO)₂-4H₂O were purchased from Alfa Aesar. Two nano-sized MgO samples, NanoActive® Magnesium Oxide (crystallite size ˜8 nm, volume weighted mean aggregate size ˜16 μm) and NanoActive® Magnesium Oxide Plus (crystallite size ˜4 nm, volume weighted mean aggregate size ˜16 μm), were ordered from NanoScale Corporation (Manhattan, Kans., US).

Pure CaO samples were prepared by direct thermal decomposition of CaO-containing sources at 800° C. for 2 hr in air. Four different methods were used to prepare MgO-doped CaO absorbents. Table 1 briefly summarizes these methods.

TABLE 1
Preparation methods for MgO-doped CaO absorbents

| Method | Details |
|---|---|
| Co- | Precipitation of aqueous solution containing Ca and Mg |
| precipitation | acetates with 1 M Na₂CO₃, followed by filtration, dryness, |
| | and calcination in air at 800° C. for 2 hr. |
| Solution | Direct dryness of aqueous solution containing Ca and Mg |
| mixing | acetates, followed by calcination in air at 800° C. for 2 hr. |
| Dry physical | Overnight ball-milling of solid CaO and MgO sources, |
| mixing | followed by calcination in air at 800° C. for 2 hr. |

High Temperature Carbonation-decarbonation Performance Measurement. A Netzsch 409C thermogravimetric analyzer (TGA) was used to screen the performance of absorbents. Typical measurements employed ˜20 mg powder, and the carbonation-decarbonation test was carried out at a fixed temperature, 758° C. During each test, 30 ml/min 100% CO₂ (for carbonation) and 60 ml/min pure He (for decarbonation) were introduced into the system alternatively via an automated switch valve every 30 minutes. The cyclic number varied according to the performance of each absorbent. In order to compare the performances of stable absorbents, 50-100 carbonation-decarbonation cycles were normally carried out. CO₂ absorption capacity was calculated using the total weight gain during each carbonation cycle divided by the total weight of absorbent in the oxide form. CaO utilization was calculated as the percentage of CaO converted to CaCO₃, based on CO₂ capacity and CaO concentration in the absorbent.

Characterization. Scanning electron microscopy (SEM) analysis was carried out with a JEOL JSM-5900LV microscope. Selected area energy dispersive X-ray spectroscopy (EDS) was performed on regions of interest using a Links EDS system equipped on the microscope. Powder X-ray Diffraction (XRD) measurement and analysis were conducted with a Philips PW3050 diffractometer using Cu Kαradiation and JADE, a commercial software package. The nitrogen BET surface area was measured with a QUANTACHROME AUTOSORB 6-B gas sorption system with degassed samples.

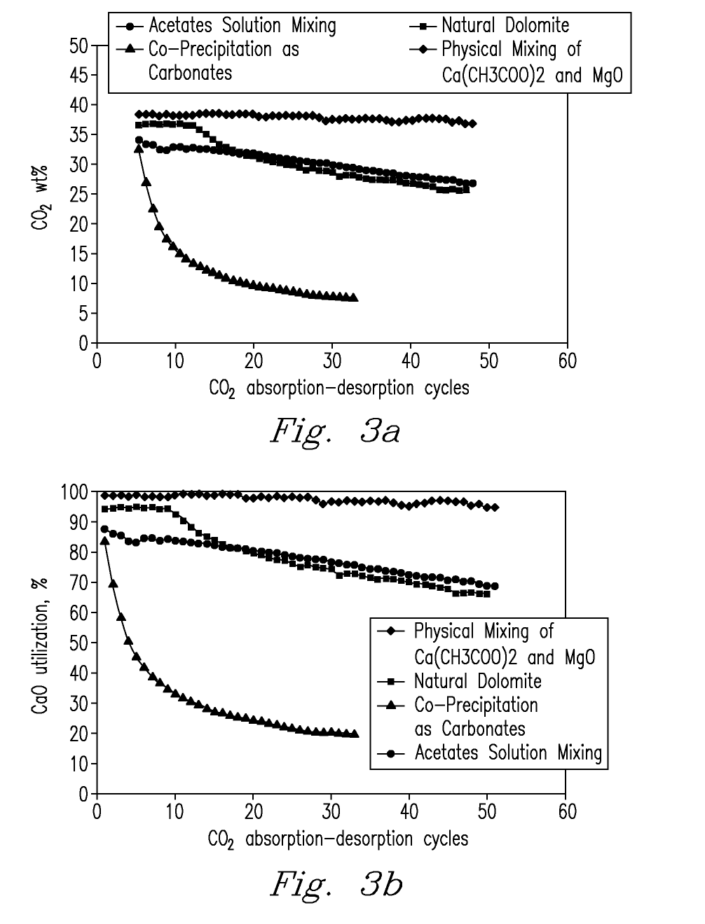

FIG. 3 shows the CO₂ capture performances of these various materials as well as those of a natural mineral with similar Ca—Mg ratio, dolomite. Although all these four samples have same quantities of base materials, their long-term performances are surprisingly different. The absorbent obtained from co-precipitation of Ca(CH₃COO)₂ and Mg(CH₃COO)₂ with Na₂CO₃ gives the worst performance, with less than 10 wt % CO₂ capacity after 30 cycles. Ca(CH₃COO)₂ and Mg(CH₃COO)₂ solution mixing followed by calcination produced an absorbent with a similar performance as that of natural dolomite, indicating molecular level mixing of CaO and MgO can be achieved with this method. The absorbent obtained from dry physical mixing of Ca(CH₃COO)₂ with MgO shows the best stability and the highest CO₂ capacity (>43 wt %), as well as the highest CaO utilization (>95%) after the 50 cycles carbonation-decarbonation test.

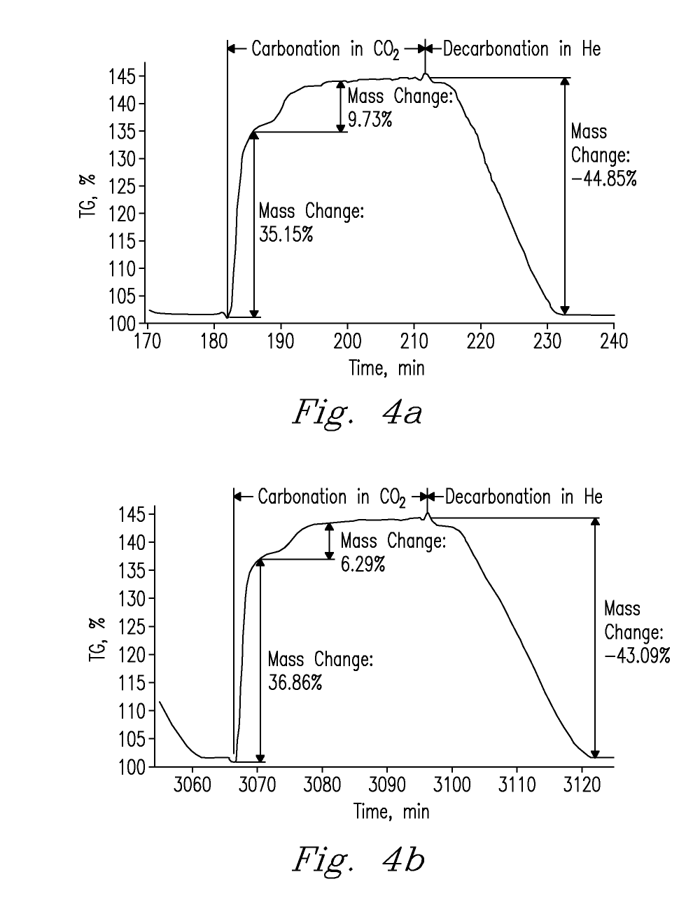

FIG. 4 shows the carbonation and decarbonation reactions of this absorbent at the 2^{nd} and the 50^{th} cycle. During the carbonation steps of both the 2^{nd} cycle and the 50^{th} cycle, more than 80% of total CO₂ capture happens within the first 4 minutes, indicating this absorbent has good CO₂ capture kinetics. On the other hand, it takes about 17 minutes (the 2^{nd} cycle) and about 20 minutes (the 50^{th} cycle) to completely regenerate the CO₂-loaded absorbent after changing the TGA flow gas from CO₂ to He. Based on thermodynamic calculation, temperatures higher than 758° C. are preferred to decompose CaCO₃. To accelerate the decarbonation step and to get high concentration CO₂ streams, a combined CO₂ pressure swing-calcination temperature swing process should be used in practical applications.

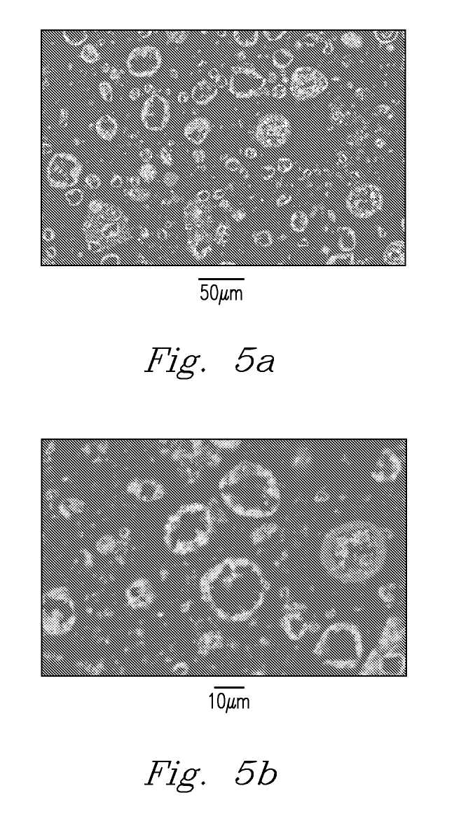

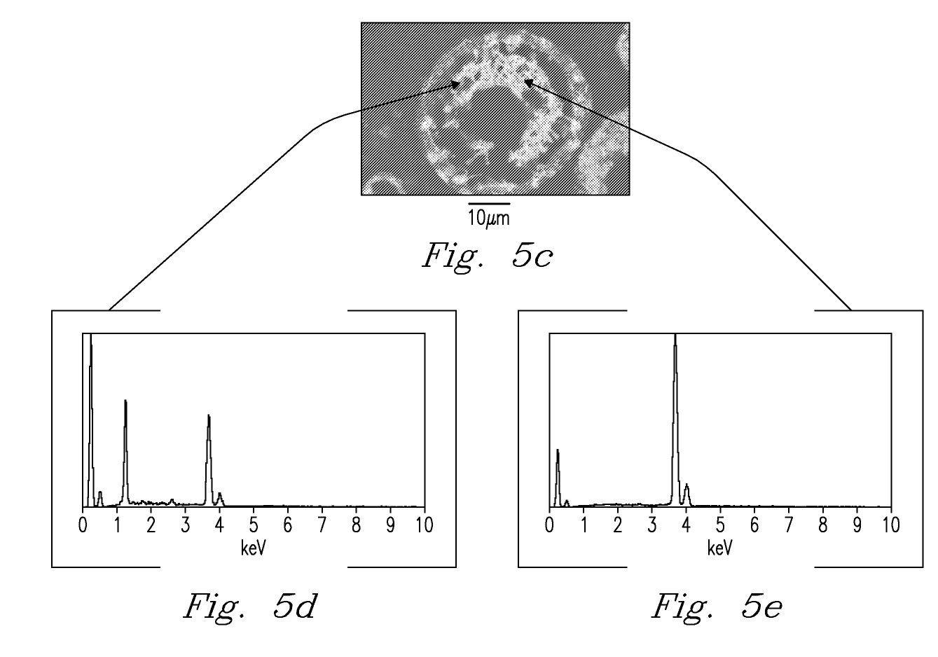

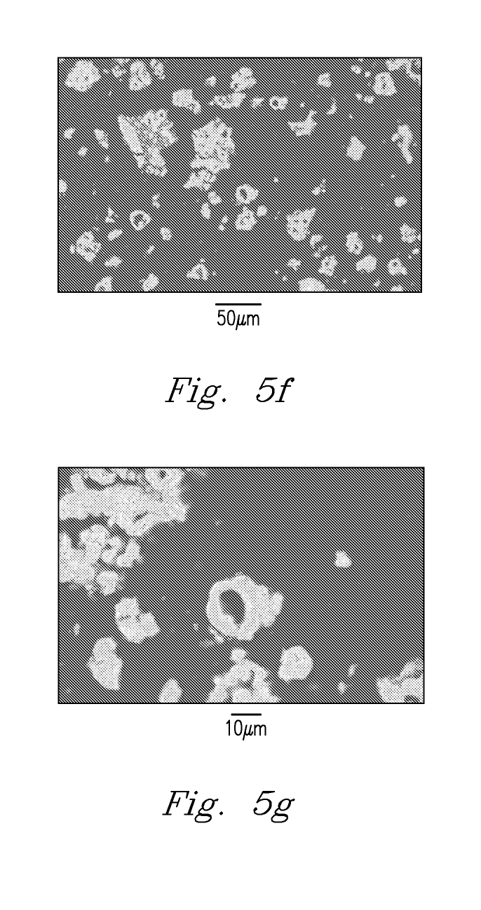

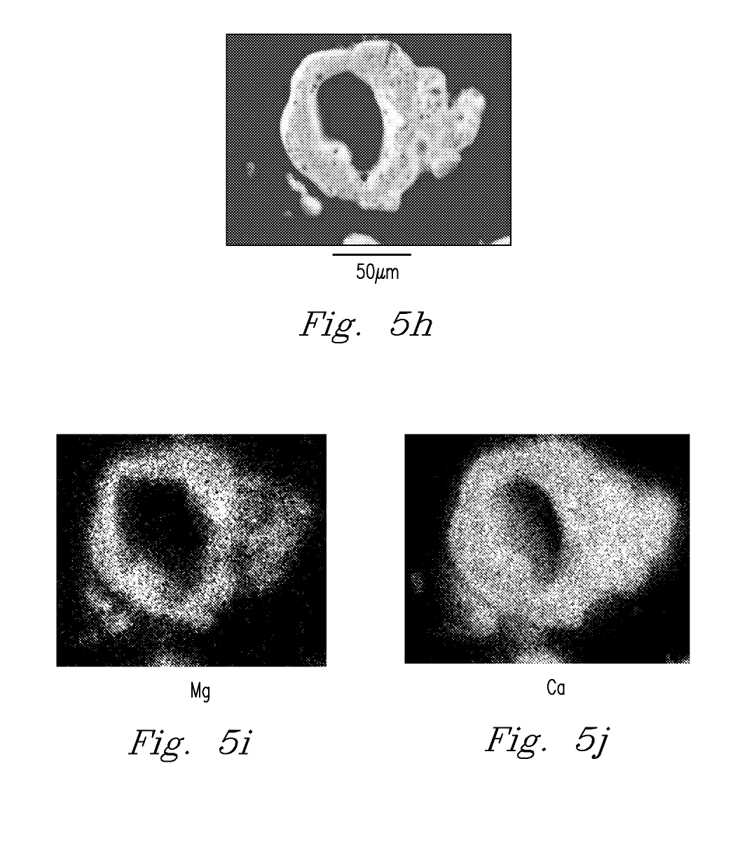

By physical mixing of Ca(CH₃COO)₂ with MgO obtained from different precursors, the effect of MgO source was evaluated. In order to accelerate the screening process, 26 wt % MgO-doped absorbents were used. Table 2 compares their performances. In general, the effect of MgO source is not as large as that of CaO source. Except one absorbent with MgO from decomposition of Mg(OH)₂, all the MgO-doped samples show much better long-term performances than pure CaO absorbents. Among all the tested samples, MgO obtained from thermal decomposition of MgC₂O₄ at 700° C. shows the best performance. Even after 100 cycles, the CaO absorbent containing 26 wt % of this MgO still has 45 wt % CO₂ capacity, corresponding to 77% total CaO utilization. However, SEM analysis shows there are dramatic morphology change and CaO and MgO particles re-distribution after the 100 cycles carbonation and decarbonation test (FIG. 5). Although some particle sintering was observed after the cycling test, the absorbent still maintained a porous structure. We believe this is the major contributor to the observed good CO₂ capture performance. Uniform mixing of MgO and CaO particles was developed after the 100 cycles test.

TABLE 2
Effect of MgO source on the performance of 24 wt % MgO-doped CaO
absorbent^{a,b,c}

| | CO₂ capacity at different carbonation- | | | |
|---|---|---|---|---|
| | decarbonation cycles, wt % | | | |
| | 5^{th} | | | |
| MgO source | cycle | 25^{th} cycle | 50^{th} cycle | 100^{th} cycle |
| No MgO doping | 60.8 | 36.2 | 27.0 | N.M. |
| MgO (~325 μm) | 47.9 | 45 | 42.2 | N.M. |
| NanoActive ® MgO (~8 nm) | 46.2 | 44.3 | 41.1 | N.M. |
| NanoActive ® MgO Plus | 47.9 | 48.0 | 47.9 | N.M. |
| (~4 nm) | | | | |
| MgO from decomposition | 49.1 | 46.5 | 34.1 | N.M. |
| of Mg(OH)₂ at 800° C., 2 hr | | | | |
| MgO from decomposition | 49.0 | 44.3 | N.M. | N.M. |
| of Mg(CH₃COO)₂ at 700° C., | | | | |
| 2 hr | | | | |
| MgC₂O₄ | 50.5 | 49.6 | 44.7 | N.M. |
| MgO from decomposition | 55.4 | 53.7 | 51.5 | 43.6 |
| of MgC₂O₄ at 500° C., 2 hr | | | | |
| MgO from decomposition | 55.9 | 55.0 | 52.9 | 44.1 |
| of MgC₂O₄ at 600° C., 2 hr | | | | |
| MgO from decomposition | 57.0 | 55.0 | 52.9 | 45.2 |
| of MgC₂O₄ at 700° C., 2 hr | | | | |
| MgO from decomposition | 53.9 | 52.3 | 50.7 | 45.2 |
| of MgC₂O₄ at 800° C., 2 hr | | | | |
| MgO from decomposition | 52.2 | 53.4 | 49.6 | 42.6 |
| of MgC₂O₄ at 900° C., 2 hr | | | | |
| MgO from decomposition | 50.3 | 48.9 | N.M. | N.M. |
| of MgC₂O₄ at 1000° C., 2 hr | | | | |

^{a}All the absorbents were prepared using dry physical mixing of Ca(CH₃COO)₂ with MgO source, followed by calcination at 800° C. in air for 2 hours.
^{b}Carbonation at 758° C. in 100% CO₂ for 30 min, decarbonation at 758° C. in 100% He for 30 min.
^{c}N.M. = not measured.

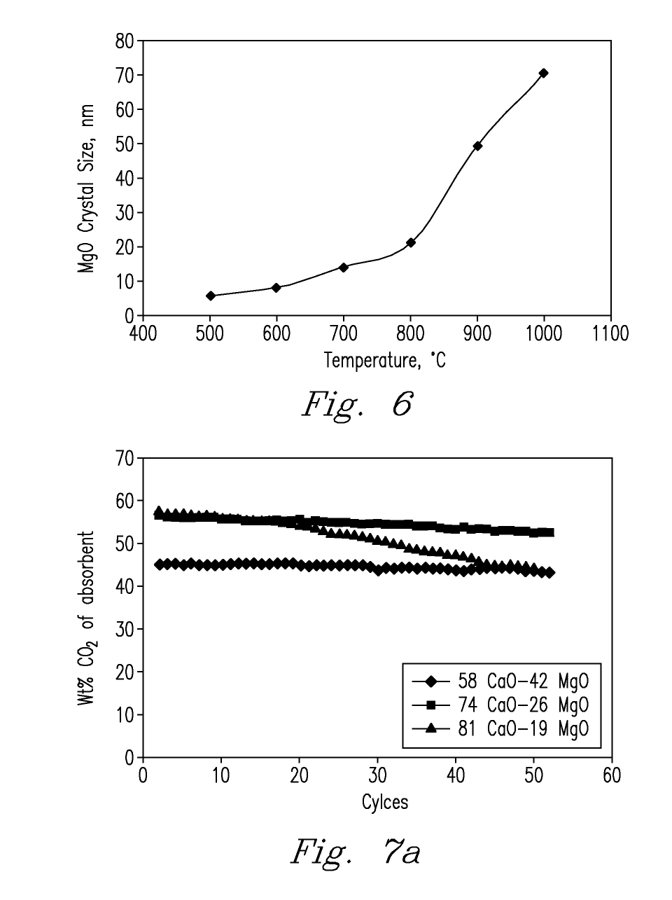

All the MgO samples obtained from decomposition of MgC₂₄ at different temperatures were characterized using XRD analysis and the MgO crystallite size was roughly estimated using Jade Software based on Scherrer's equation. FIG. 6 shows very small MgO crystallites can be obtained by direct thermal decomposition of MgC₂₄ below 800° C. The surface area of the MgO sample prepared by calcination of MgC₂O₄ at 600° C., as measured by BET method, is 181 m²/g. If all the small MgO crystallites are considered to be spherical and theoretical MgO density (3.58 g/cm³) is used, the calculated MgO crystallite size is about 9 nm, which is close to that estimated from XRD analysis (˜8 nm). As shown in Table 2, these small MgO particles, even with only 26 wt % loading, can effectively improve the CO₂ capture performances of CaO-based absorbents. Table 2 also shows two commercial nano MgO samples are not as effective, probably due to MgO particles agglomeration (manufacture-reported volume weighted mean aggregate size is ˜16 μm) in these two products.

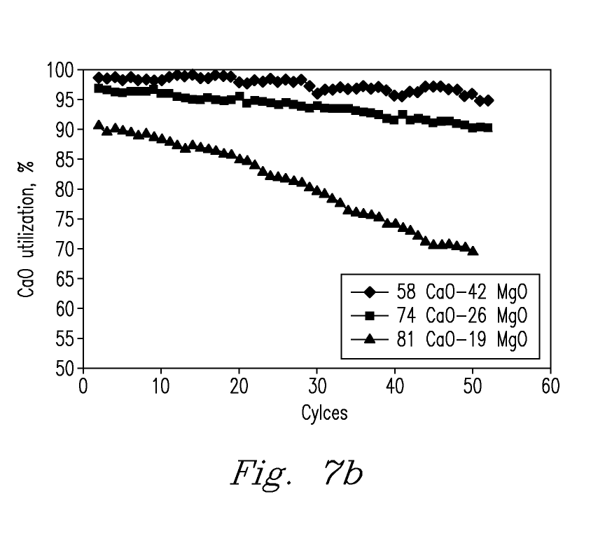

To optimize the absorbent's composition, the effect of MgO concentration in CaO absorbent was studied. The absorbents were prepared by dry physical mixing of Ca(CH₃COO)₂ with MgO obtained from calcination of Mg₂C₂O₄ at 700° C. FIG. 7 gives the performances of absorbents with 19, 24, and 42 wt % MgO doping. Higher MgO doping gives better stability and higher CaO utilization, but relatively lower CO₂ capacity. In practical applications, the optimized MgO doping level will be largely decided by the operation cost, especially by the cost of the absorbent and the absorbent replacement ratio during each cycle. An economic evaluation needs to be carried out before a meaningful recommendation of absorbent composition can be given.

In summary, we discovered the sintering effect of CaO-based CO₂ absorbents can be effectively mitigated by doping MgO nanoparticles into porous-structured CaO materials. Doping method plays an important role in producing stable absorbents. Among the three preparation methods used in this work, i.e. solution mixing, co-precipitation, and physical mixing, physical mixing produces the most durable absorbents with high CO₂ capacity. The source of MgO also has some effect on the performance of MgO—CaO mixture, although this effect is not as big as that of doping method. CaO doped with MgO nano particles prepared by thermal decomposition of MgC₂O₄ at 700° C. shows the best performance. With 26 wt % doping of MgO prepared by this method, a CaO—MgO physical mixture gives more than 50 wt % CO₂ capacity (more than 77% total CaO utilization) for 50 cycles of carbonation-decarbonation at 758° C. Without MgO doping, the CO₂ capacity of pure CaO obtained from same source decreases from 66 wt % for the 1^{st} cycle to 26 wt % for the 50^{th} cycle under the same test conditions.

While various preferred embodiments of the invention are shown and described, it is to be distinctly understood that this invention is not limited thereto but may be variously embodied to practice within the scope of the following claims. From the foregoing description, it will be apparent that various changes may be made without departing from the spirit and scope of the invention as defined by the following claims.

1. A method for making a CO₂ absorbent having a stable porous structure said method characterized by:
physically dry mixing Ca(CH₃COO)₂ with inert nanoparticles having a size less than 10 nms in an essentially nitrate free environment to form a nitrate free mixture and calcining this mixture to form a stable porous microstructure having CO₂ absorbent properties.

2. (canceled)

3. The method of claim 1 wherein said inert nanoparticles comprise MgO.

4. The method of claim 1 further comprising the step of forming said porous CaO material after mixing by decomposition.

5. The method of claim 4 wherein said decomposition is thermal decomposition.

6. (canceled)

7. The method of claim 6 wherein said inert nanoparticles comprise MgO.

8. The method of claim 7 wherein said nanoparticles have a mean size smaller than 20 nms.

9. The method of claim 1 wherein said inert material is selected from the group consisting of Al₂O₃, SiO₂, TiO₂, ZrO₂, and lanthanide oxides.

10. (canceled)

11. A method for making a CO₂ absorbent, said mixture comprising the steps of:
physically dry mixing Ca(CH₃COO)₂ with inert MgO nanoparticles having a size less than 10 nms in an essentially nitrate free environment to form a mixture; and
calcining said mixture.

12. The method of claim 11 wherein said nanoparticles having a particle size less than 20 nanometers.

13. A CO₂ adsorbent having a porous structural feature resulting from creation by a process wherein an essentially nitrate free Ca-containing material is dry physically_mixed with a preselected nitrate free nanoparticle having a size less than 10 nms to form a mixture that then is calcined to form the porous structural feature.

14. The method of claim 1 further comprising the step of thermally decomposing a mixture of inert particles and CaO precursor material.
